(19) United States
(12) Patent Application Publication
(10) Pub. No.: US 2004/0049655 A1
(43) Pub. Date: Mar. 11, 2004

(54) Method and apparatus for communication to threads of control through streams

(76) Inventor: David S. Allison, San Ramon, CA (US)

Correspondence Address: ROSENTHAL & OSHA L.L.P. / SUN, 1221 MCKINNEY, SUITE 2800, HOUSTON, TX, 77010, US

(21) Appl. No.: 09/977,715

(22) Filed: Oct. 12, 2001

(51) Int. Cl. G06F 9/30

(52) U.S. Cl. 712/200

(57) ABSTRACT

The present invention provides a method and apparatus for communication to threads of control through streams. According to one embodiment, the streams are standard stream operators in a dynamically typed language. According to another embodiment, the same mechanism (via streams) used for program input and output of a dynamically typed language is used for communication with running threads. According to yet another embodiment, a thread is assigned 2 streams when it is created. The thread can read from one stream (call it input) and write to the other stream (call it output) using the standard stream operator. Furthermore, a parent thread (a thread that starts a child thread) can also use the 2 streams mentioned above to send and receive data from a child thread using the standard stream operator.

### BACKGROUND OF THE INVENTION

1. Field of the Invention

The present invention relates primarily to the field of programming languages, and in particular to a method and apparatus for communication to threads of control through streams.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Computer software can be roughly divided into two kinds: system programs, which manage the operation of a computer itself, and application programs, which solve problems for their users. The most fundamental of all the system programs is an operating system, which controls all the computer's resources and provides the base upon which application programs can be written.

The interface between the operating system and the application programs is defined by a set of “extended instructions”, commonly called system calls, that the operating system provides. The system calls create, delete, and use various software objects managed by the operating system. The most important of these is a process.

A process is managed by a thread, and in many distributed systems it is possible to have multiple threads within a process. These threads are used as communication channels for interprocess communication primitives, for example, semaphores, mutexes, locks, and monitor. These interprocess primitives are the only prior art way to access and manipulate a process, which makes their use difficult. Before discussing this problem, an overview of an operating system, a process, and a thread is provided.

Operating System

In the past, most computers ran standalone, and most operating systems were designed to run on a single processor. This situation has rapidly changed into one in which computers are networked together, making distributed operating systems more important.

A modem computer system consists of one or more processors, main memory (often called core memory), clocks, disks, network interfaces, terminals, and various other input/output devices, making it a complex system. In order to write programs to keep track of the various components of this complex system, and to use them correctly (and in most cases optimally), a way had to be found to shield programmers from the complexity of the hardware. The way that has gradually evolved is to put a software layer on top of the bare hardware, to manage all parts of the system, and present the user with an interface or virtual machine that is easier to understand and program. This layer of software is the operating system, and is shown in FIG. 1, which can be usually broken up into 3 main sections.

At the bottom is hardware section 100, which in many cases is itself composed of two or more layers. The lowest layer 101 contains physical devices such as wires, chips, power supply, etc. Next is layer 102 comprising of primitive software that directly controls these devices and provides a clear interface to the next layer. This primitive software, called the microprogram, is usually located in read-only memory. Layer 102 is actually an interpreter that fetches the machine language instructions such as ADD, MOVE, and JUMP, and carries them out in a series of small steps. For example, to carry out the ADD instruction, the microprogram has to determine where the numbers to be added are located, fetch them, add them, and store the results somewhere. The set of instructions that the microprogram interprets defines layer 103, viz. the machine language layer.

Middle section 104 is called the system programs section and usually houses a couple of layers. Bottom layer 105 is where the operating system sits directly on top of the hardware section. On top of the operating system layer is the rest of the system software, which has the compilers (106), editors (107), command interpreter (also known as shell 108), and other application-independent programs.

Topmost section 109 is the application programs section, which has users programs such as commercial data processing (110), engineering calculations (111), games (112), etc.

Process

A key concept in all operating systems is a process. A process is essentially a program in execution. It consists of the executable program, the program's data and stack, its program counter, stack pointer, other registers, and all the other information needed to run the program.

A process is analogous to timesharing systems, where periodically the operating system stops running one process and starts running another. For example, because the first process has had its share of CPU time in the past second. When the first process is temporarily suspended like this, the operating system has to restart the process later in exactly the same state as when it was stopped. This means that all information about the process must be explicitly saved somewhere during the suspension.

Furthermore, since modem computers can perform several processes simultaneously, it gives an illusion of parallelism to the user. But in reality, a CPU runs just one process at a time, even though it may switch from one process to another several million times within the course of one second. All the information about each process, other than the contents of its own address space, is stored in an operating system table called the process table. This table is an array (or linked list) of structures, one for each process currently in existence.

FIG. 2 illustrates how an operating system creates multiple processes (In the accompanying illustration only two processes have been shown to illustrate the point. But one skilled in the art will appreciate that the steps of creating any number of processes would follow the same path as the accompanying illustration), and attends to each giving an illusion of parallelism to a user. At box 200, a first process is created. At box 210, the operating system records the first process in its process table. At box 220, the first process loads the executable program, the program's data and stack, its program counter, stack pointer, other registers, etc. At box 230, the operating system suspends the first process to create and attend to a second process. At box 240, the operating system records the state of the first process before suspension. At box 250, the operating system records the second process in its process table. At box 260, the second process loads the executable program, the program's data and stack, its program counter, stack pointer, other registers, etc. At box 270, the operating system suspends the second process to attend to the first process. At box 280, the operating system records the state of the second process before suspension. At box 290, the operating system attends to the first process from where it left off after re-establishing the state of the first process. This back and forth between the two processes continues until both the process have finished their tasks, or one of them completes its task before the other.

Thread

In most traditional operating systems, each process has an address space and a single thread, or thread of control. This thread can be seen as a lightweight (or mini) process. Each thread runs strictly sequentially, and has its own program counter and stack to keep track of where it is. Threads share CPU, just as processes do: first one thread runs, and then another (timesharing). Only on a multi-processor do they actually run in parallel with each other.

For example, if there are three processes unrelated to each other, then they are organized like the illustration of FIG. 3A. In this organization, each unrelated process has at least one thread accessible by its program counter. On the other hand, if several threads are part of the same job and are actively and closely co-operating with each other, then they are organized like the illustration of FIG. 3B. In this organization, the process has several threads (3 in the illustration). Each thread can be accessed by its program counter.

A thread can create child threads, and can block or wait for system calls to complete, just like regular processes. While one thread is blocked, another thread in the same process can run in exactly the same manner as when a process is blocked. All threads have the same address space, which means they share the same global variables. Since every thread can access every virtual address, one thread can read, write, or even completely wipe out another thread's stack, which means that there is no protection between threads.

Unlike processes, which may be from different users and may be hostile towards one another, a thread is always owned by a single user. A user can presumably create multiple threads so they can cooperate with each other. FIG. 3C is an illustration of items in a thread and process. The items in a thread include a program counter, which keeps track of the thread in a program or process, a stack, a register set, one or more child threads, and state, which is the current state of the thread. The items in a process include an address space, one or more global variables, open files, one or more child processes, timers, signals, semaphores, and accounting information.

A thread is an independent thread of flow for interprocess communication primitives such as semaphores, mutexes, locks, and monitors that are required to access and manipulate a process. In other words, a thread is a lifeline needed to run any computer system.

Semaphore

A semaphore is a data structure that lets a programmer capture a thread in order to manipulate it. A semaphore is an interprocess communication primitive that blocks threads instead of wasting CPU time when the threads are not allowed to enter the critical sections of a process. A semaphore uses a sleep and wakeup pair to accomplish the task of blocking.

Sleep is a system call that causes a caller to block, that is, be suspended until another process wakes it up. The wakeup call has one parameter, the process to be awakened. A semaphore usually uses an integer variable to count the number of wakeups saved for future use. In other words, a semaphore could have a value of 0, indicating no wakeups were saved, or some positive value if one or more wakeups were pending.

FIG. 4 illustrates how a semaphore manipulates threads so that they can enter the critical section of a process to perform their tasks. At box 400, multiple threads are created for a process. At box 410, a semaphore allows only one thread to enter the critical section of the process. At box 420, the semaphore blocks the other threads from entering the critical section of a process when a thread is already in there by sending the other threads to sleep. At box 430, the semaphore allows thread in critical section to exit. At box 440, the semaphore wakes up one of the sleeping threads. At box 450, the new awoken thread can now enter the critical section of the process to perform its task. This waking up and sending to sleep of the multiple threads, and entering the critical section of a process continues until the process is killed or completed.

A semaphore attaches itself to a thread by instantiating certain dynamic variables so that no other threads or semaphores can have access to this particular thread as long as the current semaphore is attached to it. By attaching itself to the thread, the semaphore has full access to all of the threads' functionality. This means that the semaphore not only has access to the functions in the thread, but can manipulate them too. In other words, the functions of the threads are public domain to the semaphore making a semaphore a very powerful interprocess communication primitive.

Mutex

A mutex is another small, independent program that can be deployed in the critical section of an operating system in order to manipulate a thread. A mutex is one way to access shared data in a critical section, since it ensures that only one thread has access to this shared data at any given time. A mutex can be seen as a pre-cursor to a semaphore, or a program that comes just before the semaphore to lock a critical section of the following semaphore.

A mutex is always in one of two states, locked and unlocked using two operations, LOCK and UNLOCK, respectively. In the locked state, the LOCK attempts to lock the mutex. If the mutex is unlocked, the LOCK succeeds, and the mutex becomes locked into one atomic action. For example, if two threads try to lock the same mutex at exactly the same time, one of them wins and one of them loses. Furthermore, if a thread attempts to lock a mutex that is already locked, such as the loser above, it is blocked. The UNLOCK operation unlocks a locked mutex. If one or more threads are waiting on a mutex, exactly one of them is released. The rest continue to wait.

Lock

A lock is another small, independent program that allows a user to manipulate a thread. In its simplest form, when a process needs to read or write a file or other object, the locking mechanism first locks the process.

Locking can be done using a single centralized lock manager, or with a local lock manager on each machine for managing local files. In both cases, the lock manager maintains a list of locked files, and rejects all attempts to lock files already locked by another process. Since most modem processes do not attempt to access a file before it has been locked, setting a lock on a file keeps other processes away and ensures that it will not change during the lifetime of the transaction. Locks are usually acquired and released by the transaction system, and do not require any user action.

This basic scheme is overly restrictive, and can be improved by distinguishing read locks from write locks. For example, if a read lock is set on a file, other read locks are permitted. Read locks are set to make sure that the file does not change (i.e., exclude all writers), but there is no reason to forbid other transactions from reading the file. In contrast, when a file is locked for writing, no other locks of any kind are permitted. Thus, read locks are shared, but write locks must be exclusive.

Monitor

A monitor is a higher level synchronization primitive, which is a collection of procedures, variables, and data structures that are all grouped together in a special kind of module or package. Processes may call procedures in a monitor whenever they want to, but they cannot directly access a monitor's internal data structures from procedures declared outside the monitor. Illustrated below is a monitor written in a pseudo-imaginary code:

| | |
|---|---|
| monitor | x; |
| integer | i; |
| condition | c; |

procedure a (x);
.
.
end;
procedure b(x);
.
.
end;
end monitor;

Monitors have an important property that makes them useful for achieving mutual exclusion (only one process can be active in a monitor at any instance). Monitors are a programming language construct, so the compiler knows they are special and can handle calls to monitor procedures differently from other procedure calls. Typically, when a process calls a monitor procedure, the first few instructions of the procedure checks to see if any other process is currently active within a monitor. If so, the calling process is suspended until the other process has left the monitor. If no other process is using the monitor, the calling process enters the monitor. One way to check if any other process is currently active within a monitor, a semaphore is used. This semaphore is controlled by a mutex set to either a 1 or a 0 per condition variable.

Semaphores, locks, mutexes, and monitors are examples of synchronization primitives needed to manipulate a thread in order to access and change a process. The use of interprocess communication primitives is the only prior art way to manipulate a thread and change a process, which makes their use difficult. There is no simplified interface for handling a process.

### SUMMARY OF THE INVENTION

The present invention provides a method and apparatus for communication to threads of control through streams. According to one embodiment of the present invention, streams are standard stream operators in a dynamically typed language. According to another embodiment of the present invention, the same mechanism (streams) used for program input and output of a dynamically typed language is used for communication with running threads.

According to another embodiment of the present invention, a thread is assigned 2 streams when it is created. The thread can read from one stream, called input stream, and write to the other stream, called output stream, using a standard stream operator. Furthermore, a parent thread (a thread that starts a child thread) can also use the input and output streams mentioned above to send and receive data from a child thread using the standard stream operator.

### BRIEF DESCRIPTION OF THE DRAWINGS

These and other features, aspects and advantages of the present invention will become better understood with regard to the following description, appended claims and accompanying drawings where:

FIG. 1 is an illustration of the various layers in an operating system.

FIG. 2 is an illustration of how an operating system creates multiple processes giving an illusion of parallelism to a user.

FIG. 3A is an illustration of threads within unrelated processes.

FIG. 3B is an illustration of threads within a single process.

FIG. 3C is an illustration of items within a thread and process.

FIG. 4 is an illustration of how a semaphore manipulates threads so that they can enter the critical section of a process to perform their tasks.

FIG. 5 illustrates a server thread waiting for input, processing input and writing the results.

FIG. 6 is a table of rules for all built-in types of the present dynamically typed programming language.

FIG. 7 is a flowchart of a thread's life cycle.

FIG. 8 is a table of operations to control threads of the present invention.

FIG. 9 is a flowchart illustrating the use of input and output thread streams according to one embodiment of the present invention.

FIG. 10 is a flowchart illustrating how a parent thread uses input and output streams to send and receive data from a child thread according to one embodiment of the present invention.

FIG. 11 is an illustration of an embodiment of a computer execution environment.

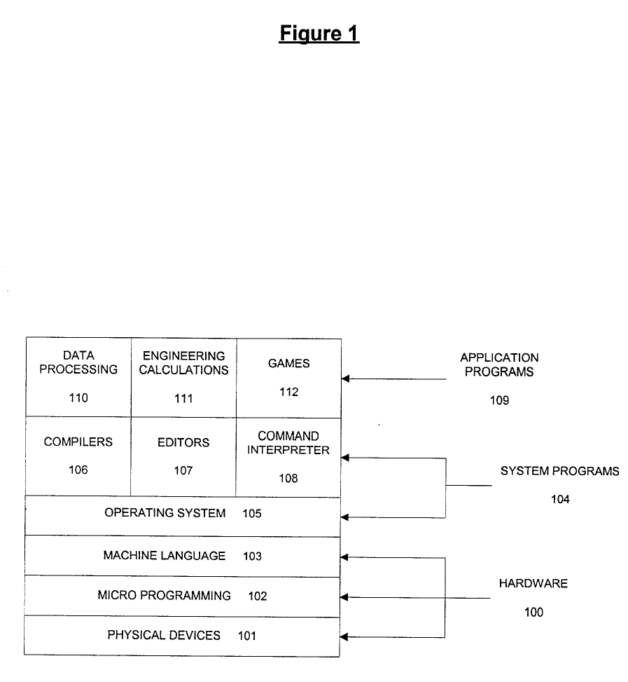

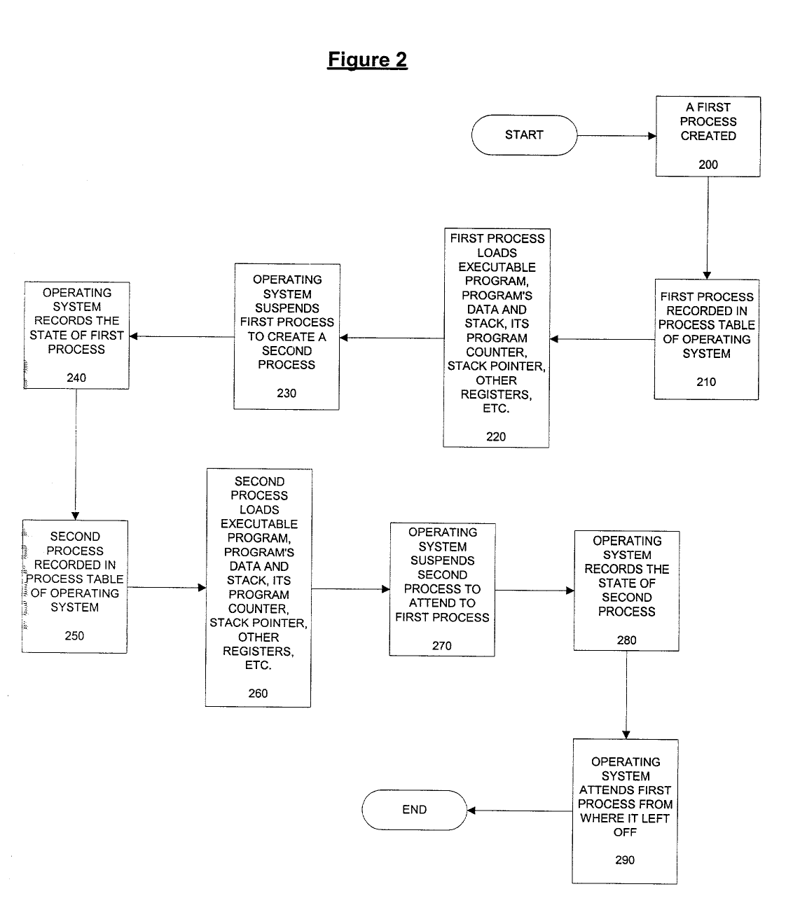

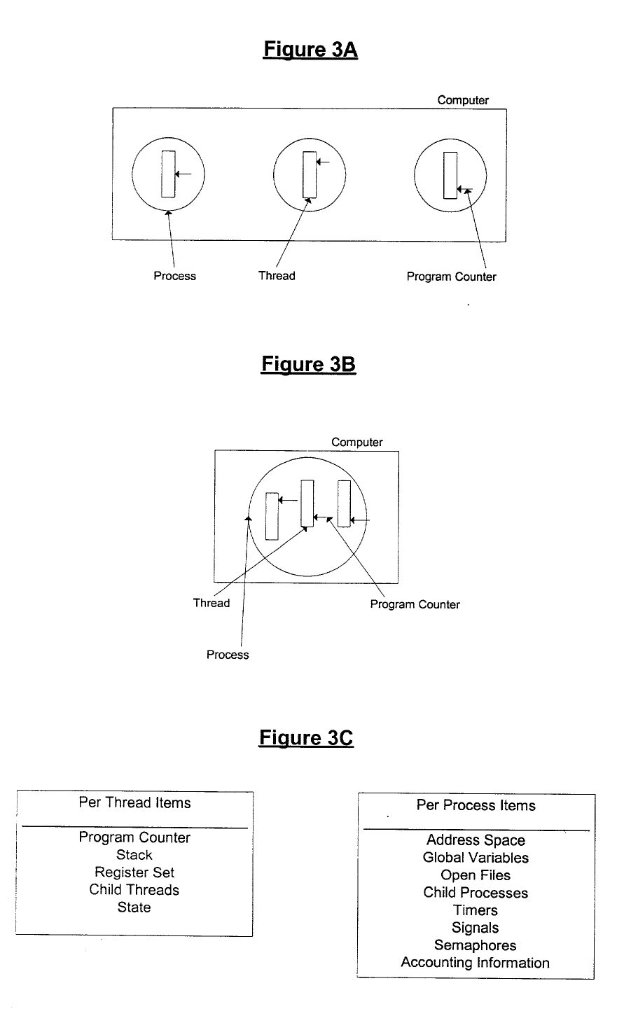

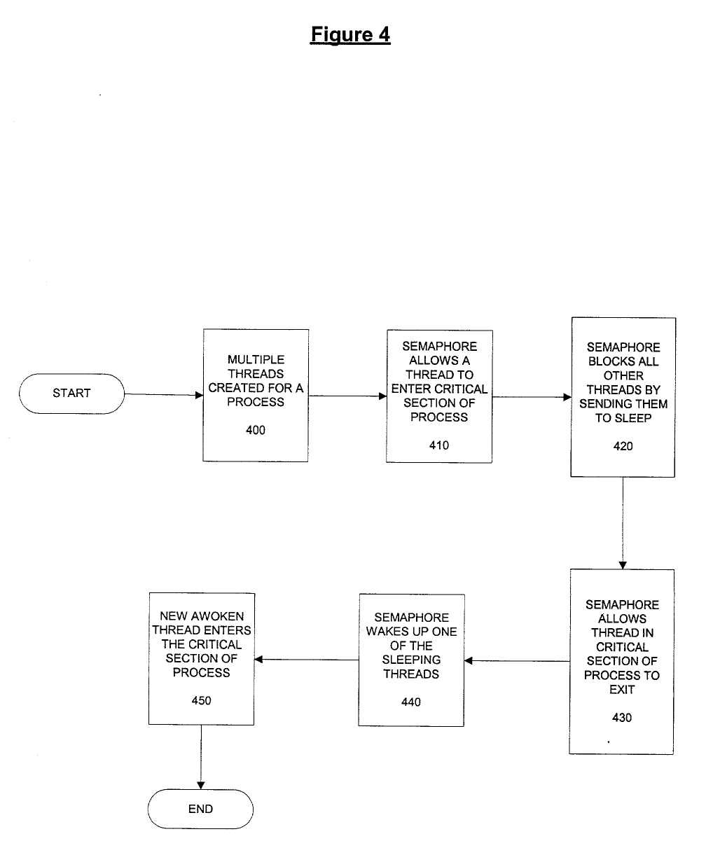

### DETAILED DESCRIPTION OF THE INVENTION

The invention is a method and apparatus for communication to threads of control through streams. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Stream

A stream in the present invention is a type of an object that is a communications channel usually connected to a device. The→operator is a stream operator that allows the contents of one value to be copied to another. For example, a stream is created when a file is opened, or a network connection is established, and looks like: stream1→stream2. This stream is built directly into the present dynamically typed programming language, and may be attached to a file, screen, keyboard, or network, etc. There are 3 predefined streams, bundled under standard streams. The 3 predefined streams include stdin, stdout, and stderr streams. These are connected to the standard input, standard output, and standard error devices of the operating system.

According to one embodiment, the present invention uses these standard stream operators to communicate with threads. A complete description of streams in a dynamically typed programming language is contained in co-pending U.S. patent application “Stream Operator In Dynamically Typed Programming Language”, Ser. No. ______ filed on ______, and assigned to the assignee of this patent application.

These standard streams are connected to the standard devices of the system, and are set up by an interpreter. There is one connection to the standard output (stdout), one to the standard input (stdin), and one to the standard error (stderr) device. For example, in order to write an error message to the standard error system, the following is done: [“Error: incorrect range:”, a, “to”, b, ‘\n’]→stderr. This creates a vector literal and uses the stream operator to write it to standard error. Similarly, in order to read from a keyboard (usually connected to standard input, but may be redirected), the following is done:

var limit=−1;

stdin→limit;

In addition to standard streams, each thread has 2 streams connected to it. According to one embodiment of the present invention, these 2 streams are connected by the system, and are called input and output streams. For the main program thread, the input stream is connected to stdin, and the output stream is connected to stdout. The reason for having separate input and output streams is to provide streams that can be redirected without worrying about overwriting the standard stream variables, and not able to direct them back again. The input and output streams are automatically connected as communications channels to any thread created. For example, consider the partial code below.

// server thread: sits waiting for an input, processes the input, and writes
the results.
thread server {

| | |
|---|---|
| while (!System.eof(input)){ | //process until stream closed |
| var command = “ ” | |
| input → command | //read command from stream |
| var result = execute (command) | //execute command |
| result → output | //writes result to output |
| System.flush(output) | //flushes the stream |

}

| | |
|---|---|
| var serverStream = server( ) | //create thread and stream |
| var result = “ ” | |
| “cat x. c/n” → serverStream | //send command to server |
| System.flush (serverStream) | //flush the stream |
| serverStream → result | //wait for result |
| } | |

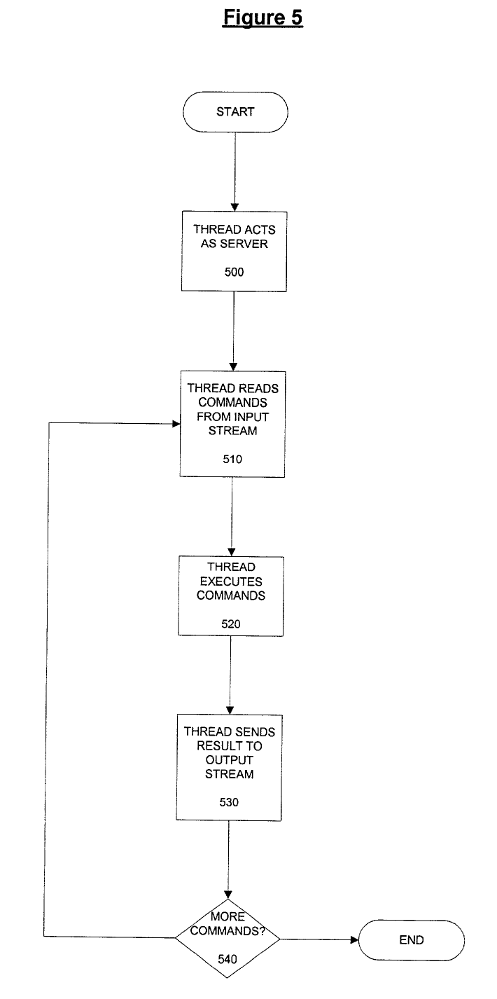

The above example can be illustrated using a flowchart. Box 500 of FIG. 5 shows a thread that acts as a server (by sitting in a loop). At box 510 it reads commands from its input stream. At box 520, it executes them, and at box 530 it sends the results to an output stream. Finally, at box 540, if there are more commands, then boxes 510 through 530 are repeated.

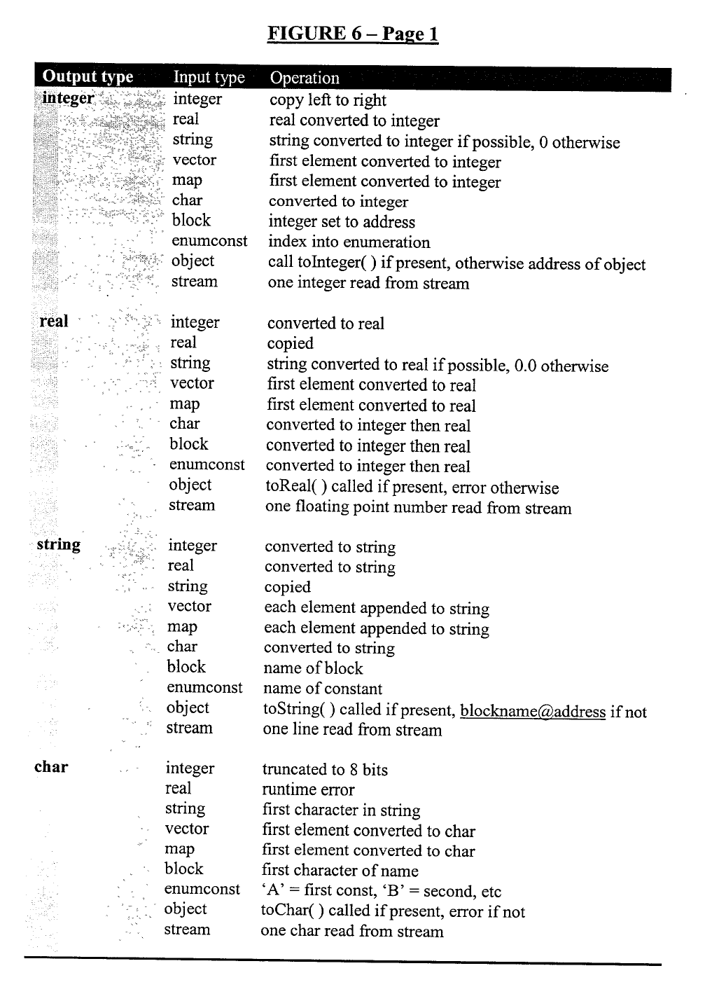

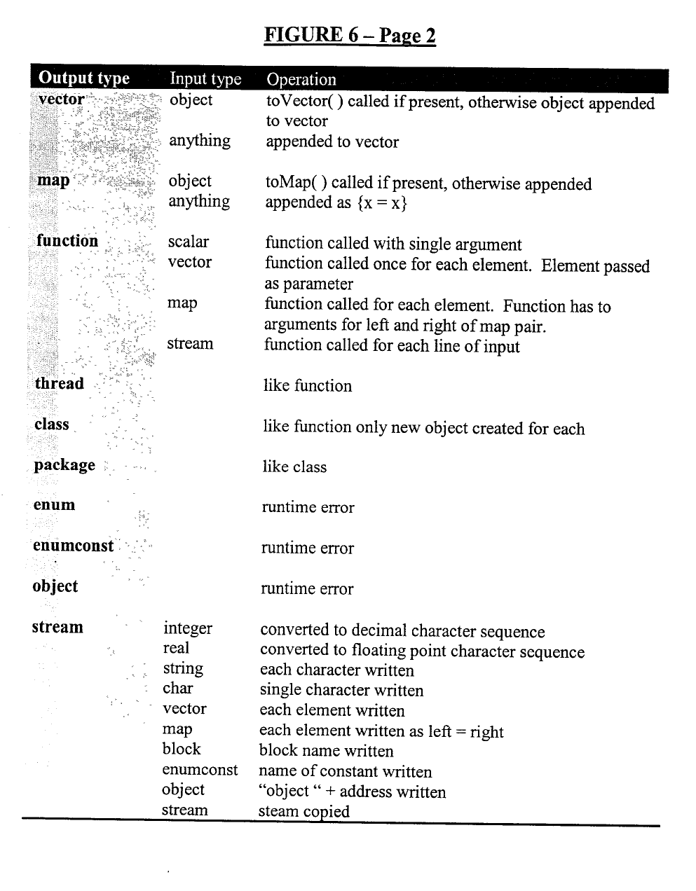

The rules for all built-in types of the present dynamically typed programming language are mentioned in a table in FIG. 6.

Thread

The present dynamically typed programming language provides a mechanism for writing programs using multiple threads. Thread synchronization facilities are provided by a user defined type called monitor that allow threads to share data with other threads, and for threads to wait for resources and notify other threads when resources become available. Monitors enforce mutual exclusion, which is essential when programming with threads. When a thread is invoked, the invoker continues execution without waiting for the tread to return. The thread then executes in parallel with the invoker and all other threads in the program, including the main program. When the thread returns, it terminates.

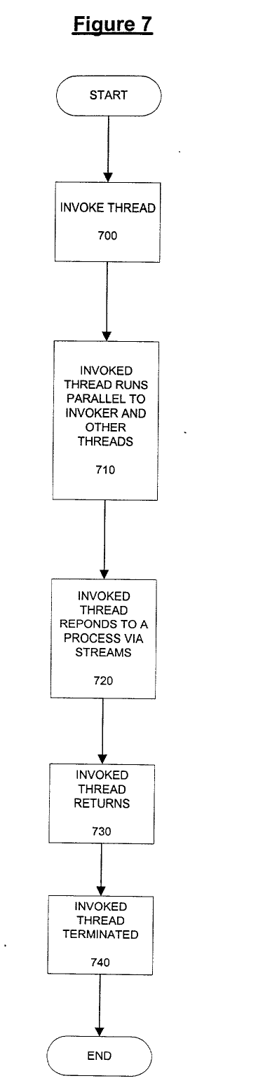

The life cycle of a thread is seen in FIG. 7, where at box 700, a thread is invoked. At box 710, the invoked thread runs parallel with the invoker and/or all other threads in the program. At box 720, the invoked thread responds to a process via streams. At box 730, the invoked thread returns to be terminated at box 740.

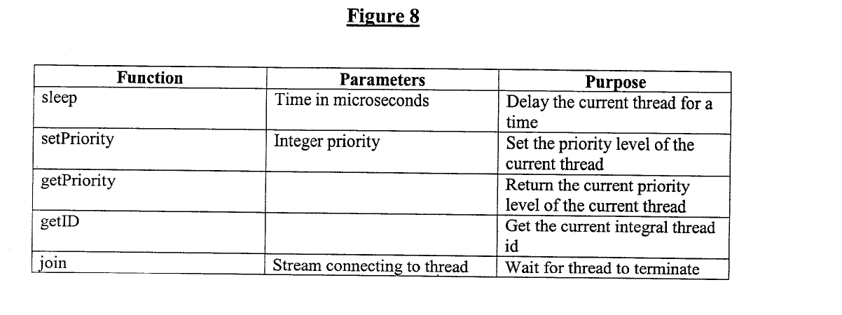

A thread is the basic support construct for a multithreaded program. A thread is a function that is called and executed in parallel with other threads in a program. A program can spawn multiple threads, and each thread can spawn other threads called child threads. There are a set of operations provided by the system to control the various threads that are common to all threads. FIG. 8 illustrates a table of these operations along with their parameters and purposes.

Thread Streams

Thread streams are used to communicate with a thread. Unlike prior art threading models that use semaphores and shared memory for one thread to talk to another, the present invention uses built-in programming language streams to communicate between threads.

As explained earlier, each thread in a program (including the main thread) gets 2 variables called input and output streams. These variables are connected to stdin and stdout respectively for the main thread. For a thread spawned inside a program, the variables are connected to the stream created for the thread. The input and output streams are the main means of communication to a thread. When a thread is created by a program, its return value is a stream connected to the thread. A caller can then use this stream to send data to and read data from the thread. The partial code for a server thread above illustrates one example of using a stream to send data to and read data from a thread.

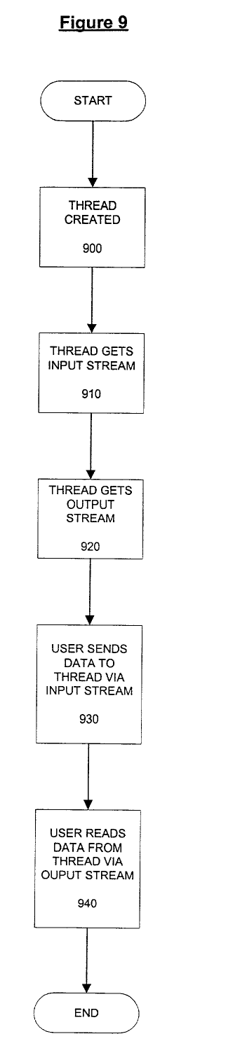

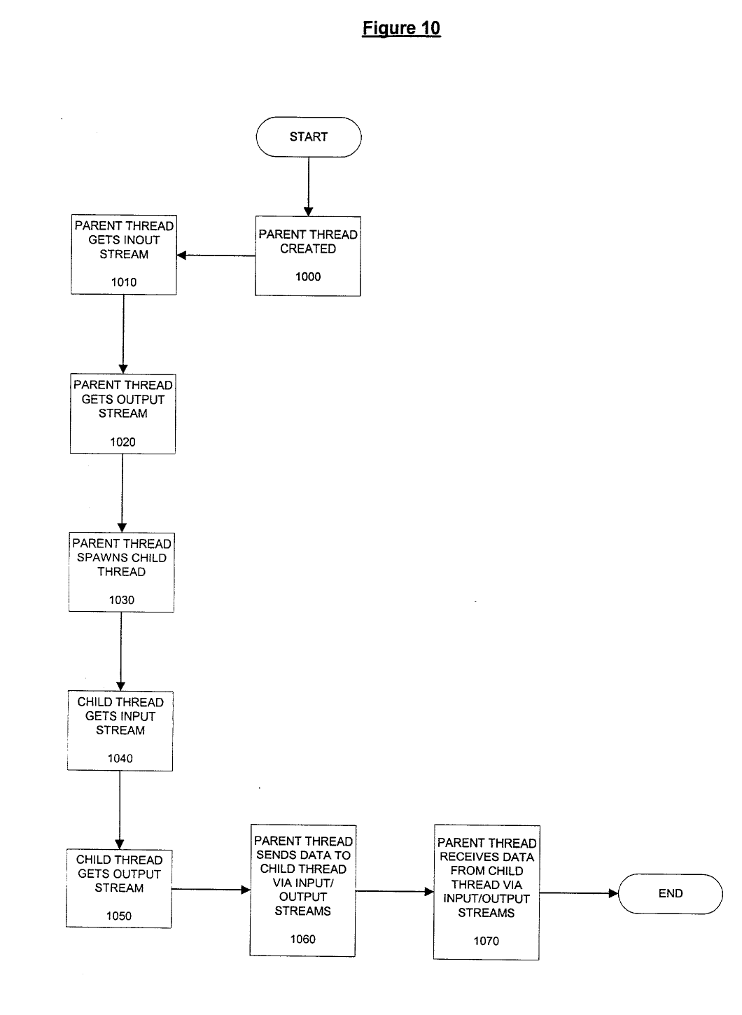

FIG. 9 illustrates the use of input and output thread streams. At box 900, a thread is created. At box 910, created thread gets an input stream. At box 920, created thread gets an output stream. At box 930, a user can send data to the created thread via the input stream, and at box 940, a user can read data from the created thread via the output stream.

According to another embodiment of the present invention, a parent thread (the thread that started a child thread) can also use the input and output streams mentioned above to send and receive data from a child thread using the standard stream operator. The parent thread is informed of the stream when the child thread is started. For example:

| | |
|---|---|
| thread server { | |
| var x = 0 | //declare an integer variable |
| input → x | //read from input |
| x → output | //write to output |
| } | |

//start server thread and get stream to it
var s = server ( )
//send the integer 1 to the thread
1 → s
//read a value from the thread to the variable ‘p’
s → p

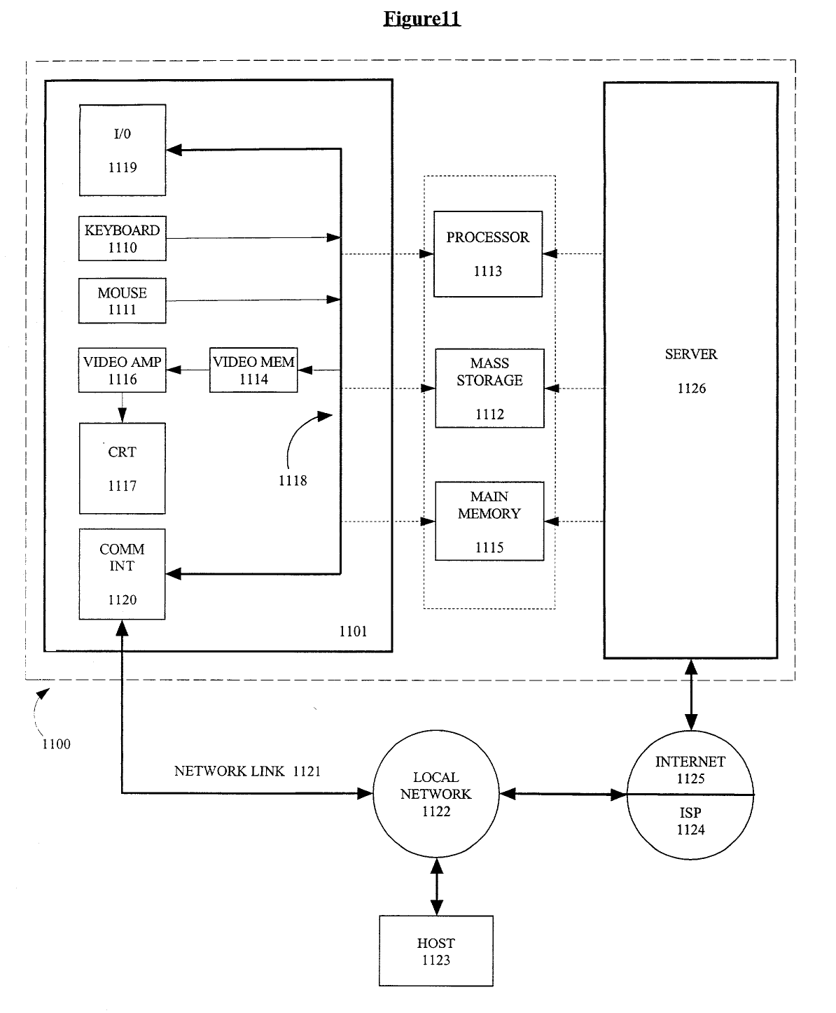

The above example can be illustrated using a flowchart. FIG. 10 illustrates how a parent thread uses input and output streams to send and receive data respectively from a child thread. At box 1000, a parent thread is created. At box 1010, the parent thread gets an input stream. At box 1020, the parent thread gets an output stream. At box 1030, the parent thread spawns a child thread. At box 1040, the child thread gets an input stream. At box 1050, the child thread gets an output stream. At box 1060, the parent thread can send data to the child thread using its output stream, which communicates with the input stream of the child thread. At box 1070, the parent thread can receive data from a child thread using its input stream, which communicates with the output stream of the child thread.

Embodiment of a Computer Execution Environment

An embodiment of the invention can be implemented as computer software in the form of computer readable code executed in a desktop general purpose computing environment such as environment 1100 illustrated in FIG. 11, or in the form of bytecode class files running in such an environment. A keyboard 1110 and mouse 1111 are coupled to a bi-directional system bus 1118. The keyboard and mouse are for introducing user input to a computer 1101 and communicating that user input to processor 1113.

Computer 1101 may also include a communication interface 1120 coupled to bus 1118. Communication interface 1120 provides a two-way data communication coupling via a network link 1121 to a local network 1122. For example, if communication interface 1120 is an integrated services digital network (ISDN) card or a modem, communication interface 1120 provides a data communication connection to the corresponding type of telephone line, which comprises part of network link 1121. If communication interface 1120 is a local area network (LAN) card, communication interface 1120 provides a data communication connection via network link 1121 to a compatible LAN. Wireless links are also possible. In any such implementation, communication interface 1120 sends and receives electrical, electromagnetic or optical signals, which carry digital data streams representing various types of information.

Network link 1121 typically provides data communication through one or more networks to other data devices. For example, network link 1121 may provide a connection through local network 1122 to local server computer 1123 or to data equipment operated by ISP 1124. ISP 1124 in turn provides data communication services through the world wide packet data communication network now commonly referred to as the “Internet” 1125. Local network 1122 and Internet 1125 both use electrical, electromagnetic or optical signals, which carry digital data streams. The signals through the various networks and the signals on network link 1121 and through communication interface 1120, which carry the digital data to and from computer 1100, are exemplary forms of carrier waves transporting the information.

Processor 1113 may reside wholly on client computer 1101 or wholly on server 1126 or processor 1113 may have its computational power distributed between computer 1101 and server 1126. In the case where processor 1113 resides wholly on server 1126, the results of the computations performed by processor 1113 are transmitted to computer 1101 via Internet 1125, Internet Service Provider (ISP) 1124, local network 1122 and communication interface 1120. In this way, computer 1101 is able to display the results of the computation to a user in the form of output. Other suitable input devices may be used in addition to, or in place of, the mouse 1111 and keyboard 1110. I/O (input/output) unit 1119 coupled to bi-directional system bus 1118 represents such I/O elements as a printer, A/V (audio/video) I/O, etc.

Computer 1101 includes a video memory 1114, main memory 1115 and mass storage 1112, all coupled to bi-directional system bus 1118 along with keyboard 1110, mouse 1111 and processor 1113.

As with processor 1113, in various computing environments, main memory 1115 and mass storage 1112, can reside wholly on server 1126 or computer 1101, or they may be distributed between the two. Examples of systems where processor 1113, main memory 1115, and mass storage 1112 are distributed between computer 1101 and server 1126 include the thin-client computing architecture developed by Sun Microsystems, Inc., the palm pilot computing device, Internet ready cellular phones, and other Internet computing devices.

The mass storage 1112 may include both fixed and removable media, such as magnetic, optical or magnetic optical storage systems or any other available mass storage technology. Bus 1118 may contain, for example, thirty-two address lines for addressing video memory 1114 or main memory 1115. The system bus 1118 also includes, for example, a 32-bit data bus for transferring data between and among the components, such as processor 1113, main memory 1115, video memory 1114, and mass storage 1112. Alternatively, multiplex data/address lines may be used instead of separate data and address lines.

In one embodiment of the invention, the processor 1113 is a microprocessor manufactured by Motorola, such as the 680x0 processor or a microprocessor manufactured by Intel, such as the 80x86 or Pentium processor, or a SPARC microprocessor from Sun Microsystems, Inc. However, any other suitable microprocessor or microcomputer may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the cathode ray tube (CRT) raster monitor 1117. Video amplifier 1116 is well known in the art and may be implemented by any suitable apparatus. This circuitry converts pixel data stored in video memory 1114 to a raster signal suitable for use by monitor 1117. Monitor 1117 is a type of monitor suitable for displaying graphic images.

Computer 1101 can send messages and receive data, including program code, through the network(s), network link 1121, and communication interface 1120. In the Internet example, remote server computer 1126 might transmit a requested code for an application program through Internet 1125, ISP 1124, local network 1122 and communication interface 1120. The received code may be executed by processor 1113 as it is received, and/or stored in mass storage 1112, or other non-volatile storage for later execution. In this manner, computer 1100 may obtain application code in the form of a carrier wave. Alternatively, remote server computer 1126 may execute applications using processor 1113, and utilize mass storage 1112, and/or video memory 1115. The results of the execution at server 1126 are then transmitted through Internet 1125, ISP 1124, local network 1122, and communication interface 1120. In this example, computer 1101 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for communication to threads of control through streams is described in conjunction with one or more specific embodiments. The invention is defined by the following claims and their full scope of equivalents.

We claim:

1. A method for communication to a thread in an environment that has built-in streams comprising:
associating a first stream with said thread;
associating a second stream with said thread; and
executing said thread comprising:
using said first stream and said second stream.

2. The method of claim 1 wherein said built-in streams of said environment are created automatically.

3. The method of claim 1 wherein at least one of said first stream and said second stream is a standard stream.

4. The method of claim 1 wherein said thread is assigned said first stream and said second stream upon creation.

5. The method of claim 1 wherein said first stream is an input stream.

6. The method of claim 1 wherein said second stream is an output stream.

7. The method of claim 6 wherein said second stream is an error stream when it is not said output stream.

8. The method of claim 3 wherein at least one of said first stream and said second stream is used by said thread to read data from a stream operator of said standard stream.

9. The method of claim 3 wherein at least one of said first stream and said second stream is used by said thread to write data to a stream operator of said standard stream.

10. The method of claim 3 wherein said first stream and said second stream are used by said thread to read data from one or more child threads.

11. The method of claim 3 wherein said first stream and said second stream are used by said thread to write data to one or more child threads.

12. A computer program product comprising:
a computer useable medium having computer readable program code embodied therein configured to communicate to a thread in an environment that has built-in streams, said computer program product comprising:
computer readable code configured therein to cause a computer to associate a first stream with said thread;
computer readable code configured therein to cause a computer to associate a second stream with said thread; and
computer readable code configured therein to cause a computer to execute said thread comprising:
computer readable code configured therein to cause a computer to use said first stream and said second stream.

13. The computer program product of claim 12 wherein said built-in streams of said environment are created automatically.

14. The computer program product of claim 11 wherein at least one of said first stream and said second stream is a standard stream.

15. The computer program product of claim 11 wherein said thread is assigned said first stream and said second stream upon creation.

16. The computer program product of claim 11 wherein said first stream is an input stream.

17. The computer program product of claim 11 wherein said second stream is an output stream.

18. The computer program product of claim 17 wherein said second stream is an error stream when it is not said output stream.

19. The computer program product of claim 14 wherein at least one of said first stream and said second stream is used by said thread to read data from a stream operator of said standard stream.

20. The computer program product of claim 14 wherein at least one of said first stream and said second stream is used by said thread to write data to a stream operator of said standard stream.

21. The computer program product of claim 14 wherein said first stream and said second stream are used by said thread to read data from one or more child threads.

22. The computer program product of claim 14 wherein said first stream and said second stream are used by said thread to write data to one or more child threads.
